(19) United States
(12) Patent Application Publication
(10) Pub. No.: US 2020/0134003 A1
(43) Pub. Date: Apr. 30, 2020

(54) INFORMATION PROCESSING APPARATUS, INFORMATION PROCESSING SYSTEM, AND NON-TRANSITORY COMPUTER READABLE MEDIUM

(71) Applicant: FUJI XEROX CO., LTD., Tokyo (JP)

(72) Inventor: Yusuke TAMURA, Kanagawa (JP)

(73) Assignee: FUJI XEROX CO., LTD., Tokyo (JP)

(21) Appl. No.: 16/389,035

(22) Filed: Apr. 19, 2019

(30) Foreign Application Priority Data
Oct. 25, 2018 (JP) 2018-200677

(51) Int. Cl. G06F 17/24; G06F 16/904

(52) U.S. Cl. CPC G06F 17/24; G06F 16/904

(57) ABSTRACT

An information processing apparatus includes a storage unit, an output unit, an acquiring unit, and a display controller. The storage unit stores first data constituted of multiple pieces of individual data each including multiple items. The output unit outputs the first data stored in the storage unit. The acquiring unit acquires second data obtained as a result of editing the first data output by the output unit. The display controller performs control to display a list of individual data having a difference between the second data acquired by the acquiring unit and the first data stored in the storage unit, the individual data having the difference being displayed for each of difference types including a newly registered type, a changed type, and a deleted type.

### CROSS-REFERENCE TO RELATED APPLICATIONS

This application is based on and claims priority under 35 USC 119 from Japanese Patent Application No. 2018-200677 filed Oct. 25, 2018.

### BACKGROUND

### (i) Technical Field

The present disclosure relates to information processing apparatuses, information processing systems, and non-transitory computer readable media.

### (ii) Related Art

Japanese Unexamined Patent Application Publication No. 2014-192874 discloses a system in which, if a comma-separated-value (CSV) file to be used when causing a controller to operate includes an abnormal value, the system detects this abnormal value and displays it to a user. The system then corrects the CSV file by converting the abnormal value into a normal value in accordance with a user operation, and causes the controller to operate based on the corrected CSV file.

### SUMMARY

Aspects of non-limiting embodiments of the present disclosure relate to providing an information processing apparatus, an information processing system, and a non-transitory computer readable medium in which, when data constituted of multiple pieces of individual data each including multiple items is edited, the efficiency at which a user checks the contents of a difference between the unedited data and the edited data may be improved, as compared with a case where a list of individual data having a difference between the unedited data and the edited data is displayed regardless of the difference types.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided an information processing apparatus including a storage unit, an output unit, an acquiring unit, and a display controller. The storage unit stores first data constituted of multiple pieces of individual data each including multiple items. The output unit outputs the first data stored in the storage unit. The acquiring unit acquires second data obtained as a result of editing the first data output by the output unit. The display controller performs control to display a list of individual data having a difference between the second data acquired by the acquiring unit and the first data stored in the storage unit, the individual data having the difference being displayed for each of difference types including a newly registered type, a changed type, and a deleted type.

### BRIEF DESCRIPTION OF THE DRAWINGS

An exemplary embodiment of the present disclosure will be described in detail based on the following figures, wherein:

FIG. 1 illustrates a system configuration of an information processing system according to an exemplary embodiment of the present disclosure;

FIG. 2 is a block diagram illustrating a hardware configuration of a user-data management server according to the exemplary embodiment of the present disclosure;

FIG. 3 is a block diagram illustrating a functional configuration of the user-data management server according to the exemplary embodiment of the present disclosure;

FIG. 4 is a flowchart for specifically explaining a difference detection process executed by a difference detector;

FIG. 5 is a flowchart for specifically explaining a difference-type determination process in the flowchart in FIG. 4;

FIG. 6A illustrates an example of unedited user data prior to being edited, and FIG. 6B illustrates an example of edited user data;

FIGS. 7A to 7C illustrate specific examples of the difference-type determination process executed by the difference detector;

FIG. 8 illustrates a display example where a “newly registered” tab has been selected by a user;

FIG. 9 illustrates a display example where a “changed” tab has been selected by the user;

FIG. 10 illustrates a display example where a “deleted” tab has been selected by the user;

FIG. 11 illustrates a display example where personal data corresponding to a changed type as a difference type does not exist;

FIG. 12 illustrates another display example where personal data corresponding to the changed type as a difference type does not exist;

FIG. 13 illustrates a display example where unchangeable items are displayed to clearly indicate that they are unchangeable;

FIG. 14 illustrates another display example where unchangeable items are displayed to clearly indicate that they are unchangeable;

FIG. 15 illustrates another display example where unchangeable items are displayed to clearly indicate that they are unchangeable;

FIG. 16 illustrates a display example where personal data displayed for each difference type is to be edited;

FIG. 17 illustrates another display example where personal data displayed for each difference type is to be edited;

FIG. 18 illustrates an error display example where an attribute value of edited user data is abnormal; and

FIG. 19 illustrates another error display example where an attribute value of edited user data is abnormal.

### DETAILED DESCRIPTION

An exemplary embodiment of the present disclosure will now be described with reference to the drawings.

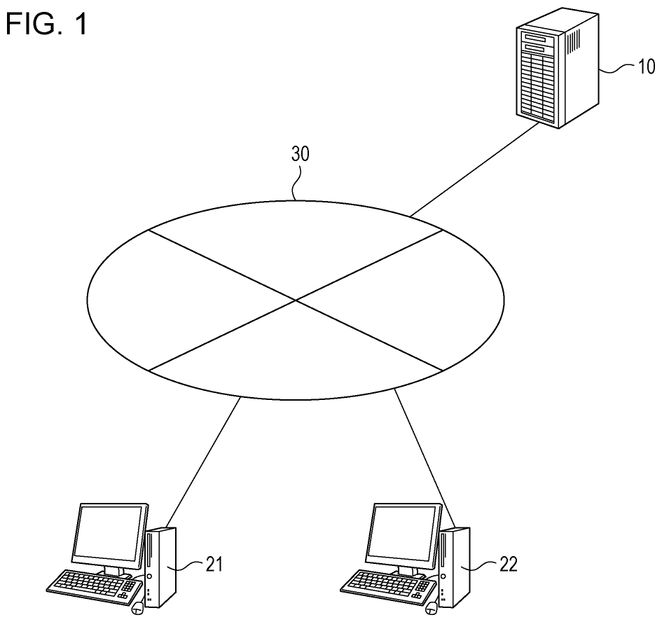

FIG. 1 illustrates a system configuration of an information processing system according to the exemplary embodiment of the present disclosure.

As shown in FIG. 1, the information processing system according to the exemplary embodiment of the present disclosure includes a user-data management server 10 and terminal apparatuses 21 and 22 as editing apparatuses for editing user data. The user-data management server 10 and the terminal apparatuses 21 and 22 are connected to one another by a network 30.

The user-data management server 10 is an information processing apparatus that manages user data constituted of multiple pieces of personal data (individual data) each including multiple items, such as a user's name, mail address, and department.

The terminal apparatuses 21 and 22 each have a function of receiving user data output in the comma separated value (CSV) format from the user-data management server 10, editing the user data, and transmitting the edited user data to the user-data management server 10.

In other words, each of the terminal apparatuses 21 and 22 functions as an editing apparatus that edits unedited user data output from the user-data management server 10 and that transmits the edited user data to the user-data management server 10.

There is also a possibility where the user-data editing process performed in the terminal apparatus 21 or 22 is incorrect or inappropriate.

Therefore, instead of immediately updating the managed user data in accordance with the edited user data received from the terminal apparatus 21 or 22, the user-data management server 10 displays a difference between the unedited user data and the edited user data and updates the managed user data in accordance with the edited user data after a manager of the user data confirms that there is no problem in reflecting the edited contents.

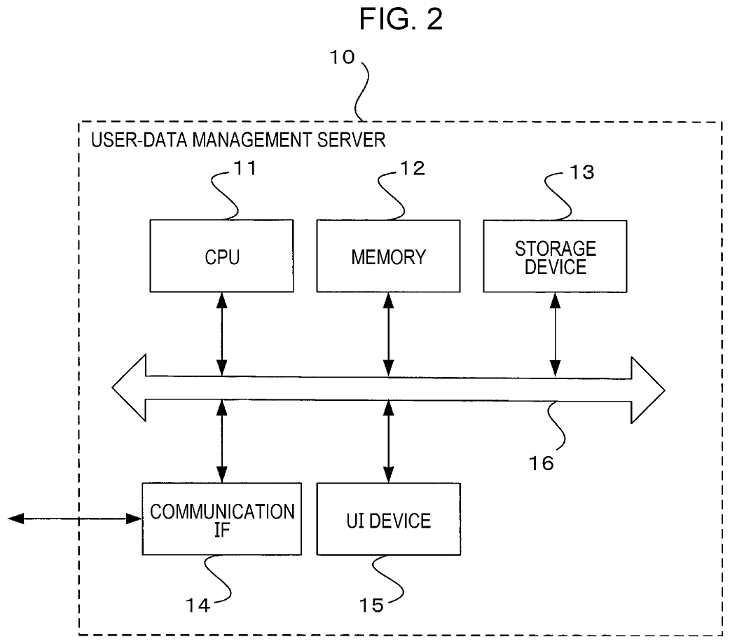

FIG. 2 illustrates a hardware configuration of the user-data management server 10 in the information processing system according to this exemplary embodiment.

As shown in FIG. 2, the user-data management server 10 includes a central processing unit (CPU) 11, a memory 12, a storage device 13, such as a hard disk drive (HDD), a communication interface (IF) 14 that transmits and receives data to and from an external apparatus, such as the terminal apparatus 21 or 22, via the network 30, and a user interface (UI) device 15 including a touchscreen or a liquid crystal display as well as a keyboard. These components are connected to one another by a control bus 16.

The CPU 11 executes a predetermined process based on a control program stored in the memory 12 or the storage device 13 so as to control the operation of the user-data management server 10. Although it is described in this exemplary embodiment that the CPU 11 reads and executes the control program stored in the memory 12 or the storage device 13, the program may be stored in a storage medium, such as a CD-ROM, and may be provided to the CPU 11.

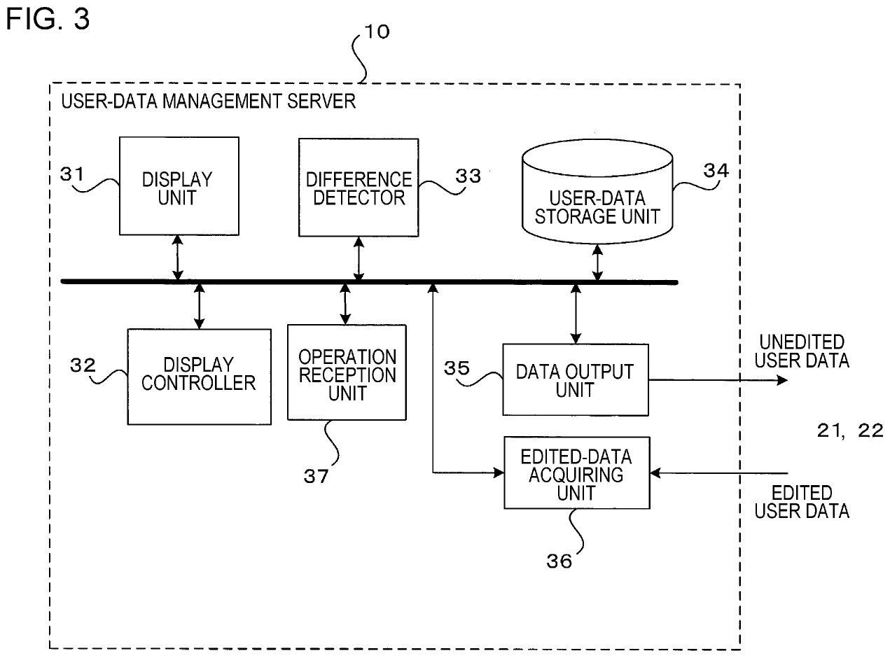

FIG. 3 is a block diagram illustrating a functional configuration of the user-data management server 10 realized as a result of executing the aforementioned control program.

As shown in FIG. 3, the user-data management server 10 according to this exemplary embodiment includes a display unit 31, a display controller 32, a difference detector 33, a user-data storage unit 34, a data output unit 35, an edited-data acquiring unit 36, and an operation reception unit 37.

The display unit 31 displays various types of information to a user.

The user-data storage unit 34 stores unedited user data constituted of multiple pieces of personal data (individual data) each including multiple items.

The data output unit 35 outputs the unedited user data stored in the user-data storage unit 34 to, for example, the terminal apparatus 21 or 22. Then, the terminal apparatus 21 or 22 edits the unedited user data output by the data output unit 35 and transmits the edited user data to the user-data management server 10.

The edited-data acquiring unit 36 acquires the edited user data edited by and transmitted from the terminal apparatus 21 or 22.

The difference detector 33 detects a difference between the unedited user data stored in the user-data storage unit 34 and the edited user data acquired by the edited-data acquiring unit 36.

Based on the detection result obtained by the difference detector 33, the display controller 32 controls the display unit 31 to display a list of personal data having a difference between the edited user data acquired by the edited-data acquiring unit 36 and the unedited user data stored in the user-data storage unit 34 for each of difference types including a newly registered type, a changed type, and a deleted type.

A newly registered type indicates that personal data not included in the unedited user data is included in the edited user data. A changed type indicates that personal data in the unedited user data has been changed in contents of any of the items in the edited user data. A deleted type indicates that personal data included in the unedited user data is not included in the edited user data.

In this exemplary embodiment, these processes of newly registering, changing and deleting personal data will collectively be referred to as a personal-data editing process.

In detail, the display controller 32 controls the display unit 31 to display all pieces of personal data corresponding to the same difference type within the same display region. For example, the display controller 32 performs control to display all pieces of personal data corresponding to the same difference type together in a single scrolling screen.

With regard to pieces of personal data of various difference types, the display controller 32 performs control to display the pieces of personal data in different display regions according to the difference types. In detail, the display controller 32 displays personal data corresponding to the newly registered type, personal data corresponding to the changed type, and personal data corresponding to the deleted type separately in different pages.

If personal data corresponding to a certain difference type does not exist, the display controller 32 may control the display unit 31 to perform display to clearly indicate that the personal data corresponding to the certain difference type does not exist.

Furthermore, the display controller 32 controls the display unit 31 to display the number of data pieces of personal data corresponding to each of the difference types.

In detail, the display controller 32 controls the display unit 31 to perform display such that the number of data pieces of personal data corresponding to each difference type is displayed above the center of the display region and a list of personal data corresponding to at least one of multiple difference types is displayed below the display region for the number of data pieces.

The operation reception unit 37 receives various types of operations performed by the user and accepts a new editing process for personal data displayed for each difference type by the display controller 32.

When personal data is to be displayed for each difference type, the display controller 32 may control the display unit 31 to perform display to clearly indicate that an unchangeable item, due to the user not having an editing authorization, is unchangeable.

Furthermore, if the multiple items constituting the personal data displayed for each difference type include an item unchangeable due to the user not having an editing authorization, the display controller 32 may provide a notification to the user by causing the display unit 31 to display a message indicating that there is an unchangeable item.

Next, the operation in the user-data management server 10 according to this exemplary embodiment will be described in detail with reference to the drawings.

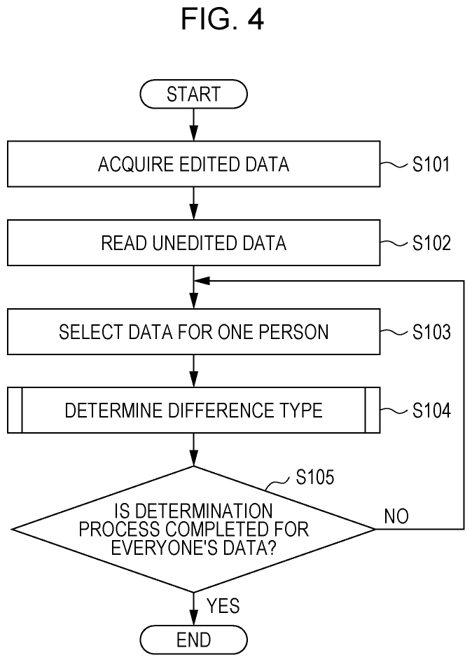

First, a difference detection process executed in the difference detector 33 of the user-data management server 10 according to this exemplary embodiment will be described in detail with reference to a flowchart in FIG. 4.

When the edited-data acquiring unit 36 acquires edited data (i.e., edited user data) from the terminal apparatus 21 or 22 in step S101, the difference detector 33 reads unedited data (i.e., user data prior to being edited) from the user-data storage unit 34 in step S102.

In step S104, the difference detector 33 first selects personal data of one person and detects a difference between unedited data and edited data with regard to this personal data, so as to determine a difference type.

In step S105, the difference detector 33 sequentially determines whether or not there is a difference with regard to each piece of personal data and also determines a difference type, until the determination process is completed for everyone's personal data.

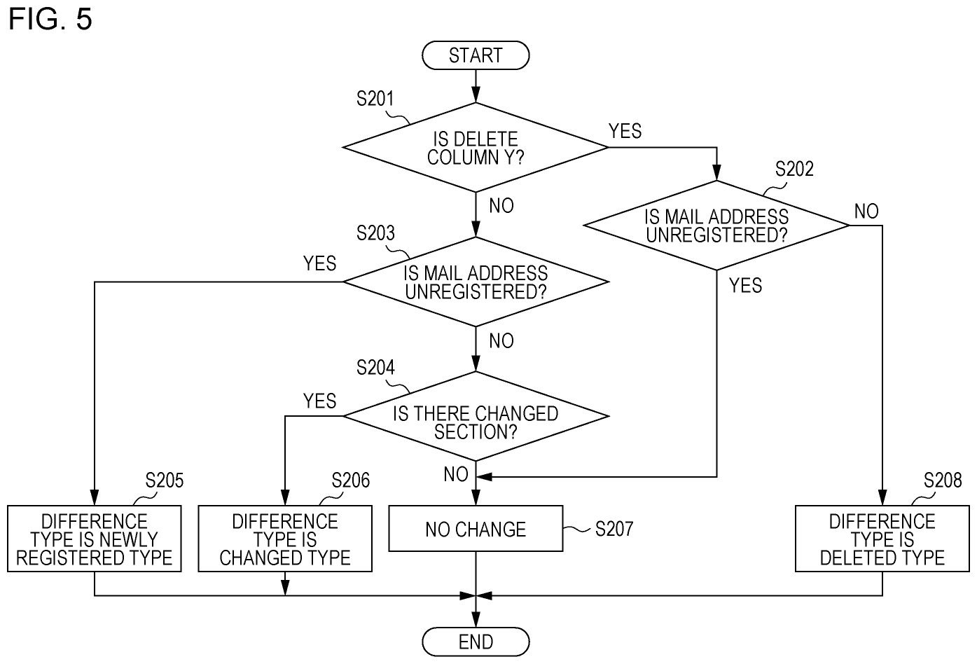

Next, the difference-type determination process (step S104) explained in the flowchart in FIG. 4 will be described with reference to a flowchart in FIG. 5.

As mentioned above, in this exemplary embodiment, the user data output from the data output unit 35 is in the CSV format. Thus, the user data edited in the terminal apparatus 21 or 22 is also in the CSV format. With regard to user data in the CSV format, the items in each piece of personal data are separated by commas. If a character “Y” is included in a delete column in each piece of personal data, the character indicates that an editing process for deleting this piece of personal data has been performed.

This exemplary embodiment relates to a case where, among multiple items in each piece of personal data, an individual is identified and each piece of personal data is managed with reference to a mail address having no possibility of redundancy. Alternatively, each piece of personal data may be managed by using information based on which each user is individually identifiable, such as an identification ID issued for each user, in place of a mail address.

First, in step S201, the difference detector 33 determines whether or not a character “Y” is included in the delete column in the edited user data.

If a character “Y” is included in the delete column (YES in step S201), the difference detector 33 determines in step S202 whether or not the mail address of this personal data is unregistered in the unedited user data.

If the mail address is not unregistered (NO in step S202), the difference detector 33 determines in step S208 that the difference type is the deleted type.

If the mail address is unregistered (YES in step S202), the difference detector 33 determines in step S207 that there is no change since the personal data does not exist in the unedited user data to begin with.

If a character “Y” is not included in the delete column (NO in step S201), the difference detector 33 determines in step S203 whether or not the mail address of this personal data is unregistered in the unedited user data.

If the mail address is unregistered (YES in step S203), the difference detector 33 determines in step S205 that the difference type is the newly registered type.

If the mail address is not unregistered (NO in step S203), the difference detector 33 determines in step S204 whether or not there is a changed section between the unedited data and the edited data with regard to this personal data.

If there is a changed section (YES in step S204), the difference detector 33 determines in step S206 that the difference type is the changed type.

If there is no changed section (NO in step S204), the difference detector 33 determines in step S207 that there is no change.

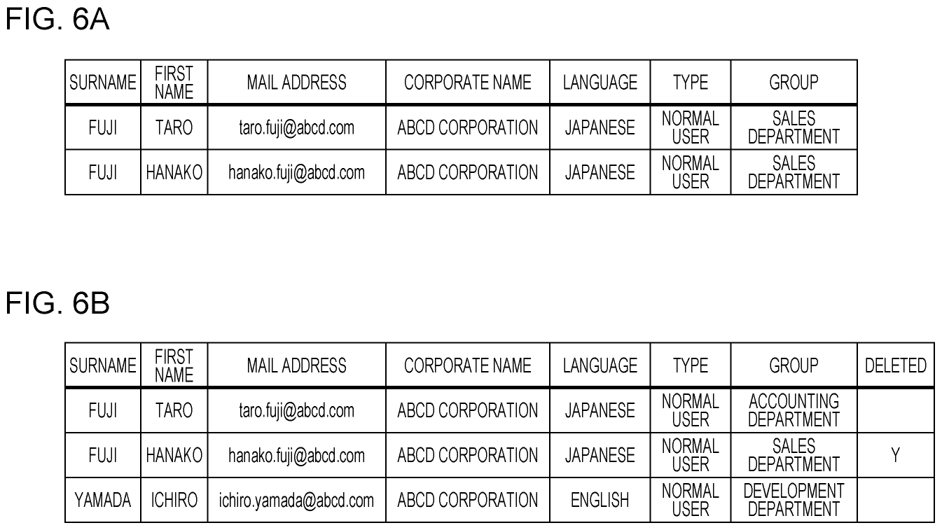

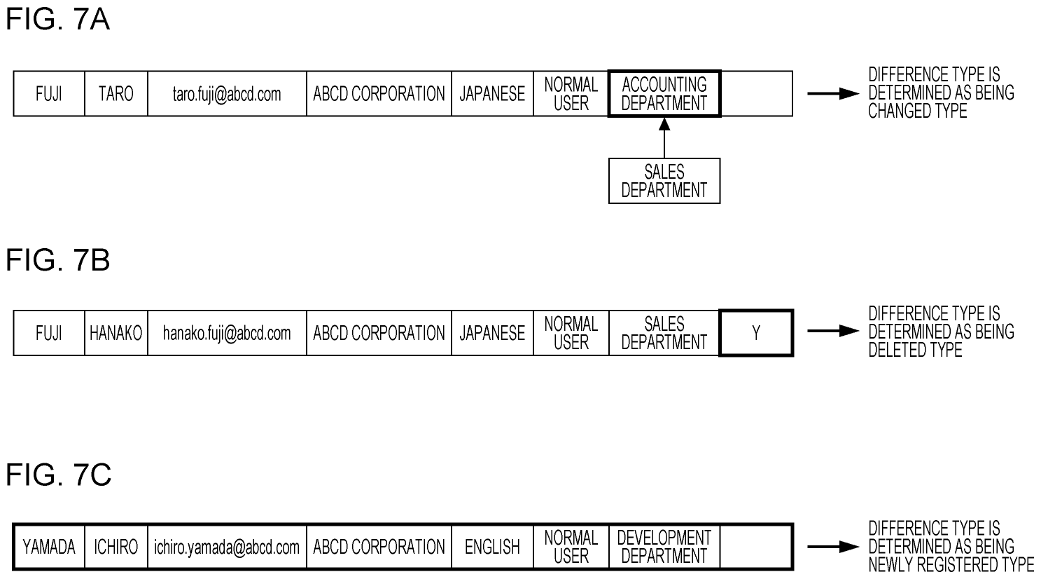

The difference-type determination process explained with reference to the flowchart in FIG. 5 will now be described with reference to specific user data shown in FIGS. 6A to 7C.

FIG. 6A illustrates an example of unedited user data, and FIG. 6B illustrates an example of edited user data. For simplifying the description, FIGS. 6A and 6B illustrate a case where the unedited user data is constituted of personal data of two people. However, in actuality, the user data is constituted of personal data of a larger number of people.

With regard to personal data for “Taro Fuji” shown in FIG. 6A, the delete column in the edited user data is blank, the mail address “taro.fuji@abcd.com” is registered, and the group has been changed from the sales department to the accounting department. Therefore, as shown in FIG. 7A, the difference detector 33 determines that the difference type with respect to this personal data is the changed type.

With regard to personal data for “Hanako Fuji” shown in FIG. 6A, the delete column in the edited user data has the character “Y” instead of being blank, and the mail address “hanako.fuji@abcd.com” is registered. Therefore, as shown in FIG. 7B, the difference detector 33 determines that the difference type with respect to this personal data is the deleted type.

Furthermore, the edited user data shown in FIG. 6B includes personal data for “Ichiro Yamada”. With regard to this personal data, the mail address “ichiro.yamada@abcd.com” is unregistered in the unedited user data, and the delete column is blank. Therefore, as shown in FIG. 7C, the difference detector 33 determines that the difference type with respect to this personal data is the newly registered type.

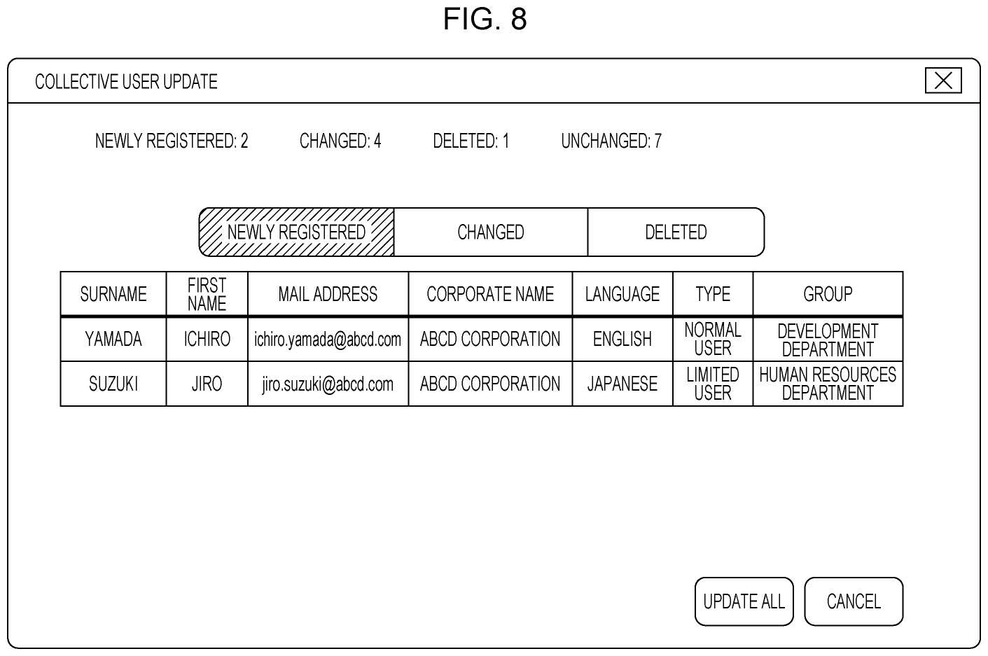

FIGS. 8 to 10 illustrate display examples in a case where the display controller 32 causes the display unit 31 to display the detection results for the respective difference types when the difference-type determination process is performed by the difference detector 33 in the above-described manner.

FIG. 8 illustrates a display example where tabs corresponding to the difference types, namely, a “newly registered” tab, a “changed” tab, and a “deleted” tab, are displayed, and the “newly registered” tab has been selected.

In the display example shown in FIG. 8, it is clear that the personal data for “Ichiro Yamada” determined as being the newly registered type as the difference type in FIG. 7C is displayed.

It is also clear that a list of the number of data pieces of personal data corresponding to each of the difference types, namely, “newly registered: 2”, “changed: 4”, “deleted: 1”, and “unchanged: 7”, is displayed above the tabs. This list of the number of data pieces is displayed above the center of the display region so that the user may easily visually recognize the list. A list of the personal data corresponding to the respective difference types is displayed below the display region of the number of data pieces.

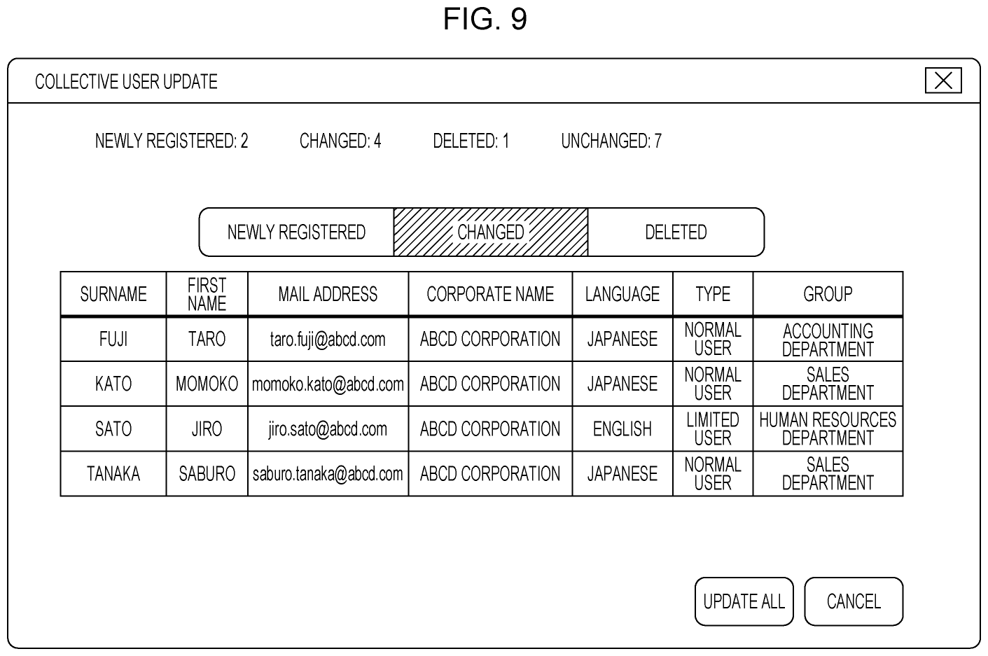

FIG. 9 illustrates a display example where the “changed” tab has been selected by the user. In the display example shown in FIG. 9, a list of personal data determined as being the changed type as the difference type is displayed. Referring to FIG. 9, it is clear that the personal data for “Taro Fuji” determined as being the changed type as the difference type in FIG. 7A is included in the list.

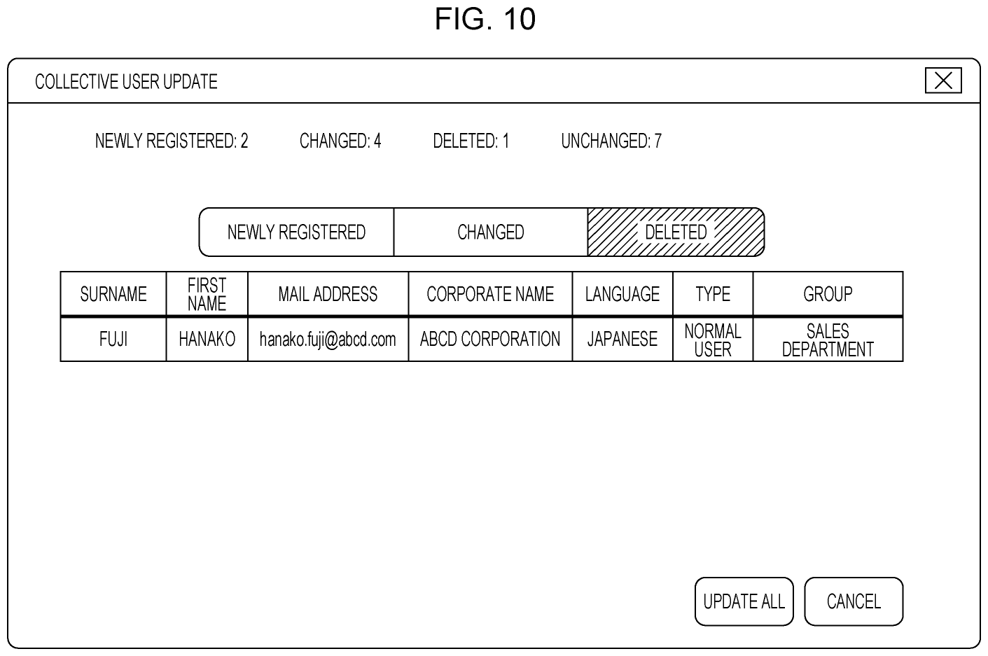

FIG. 10 illustrates a display example where the “deleted” tab has been selected by the user. In the display example shown in FIG. 10, a list of personal data determined as being the deleted type as the difference type is displayed. Referring to FIG. 10, it is clear that the personal data for “Hanako Fuji” determined as being the deleted type as the difference type in FIG. 7B is included in the list.

In a case where the user is to update the edited contents by referring to the display screen shown in any one of FIGS. 8 to 10, the user may operate an “update all” button on the display screen, so that the edited contents are reflected on the user data stored in the user-data storage unit 34.

If there is a problem in the edited contents and the user does not desire to reflect the edited contents on the user data, the user operates a “cancel” button so that the process ends without the edited contents being reflected on the user data stored in the user-data storage unit 34.

The above description with reference to FIGS. 8 to 10 relates to a case where there is at least one piece of personal data corresponding to each of the difference types, namely, the newly registered type, the changed type, and the deleted type.

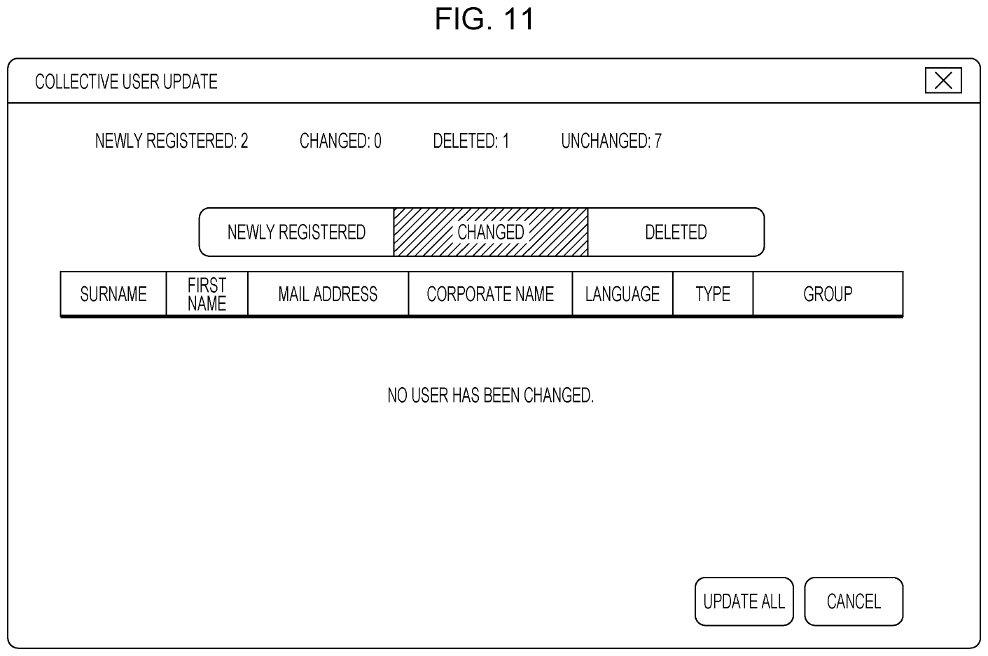

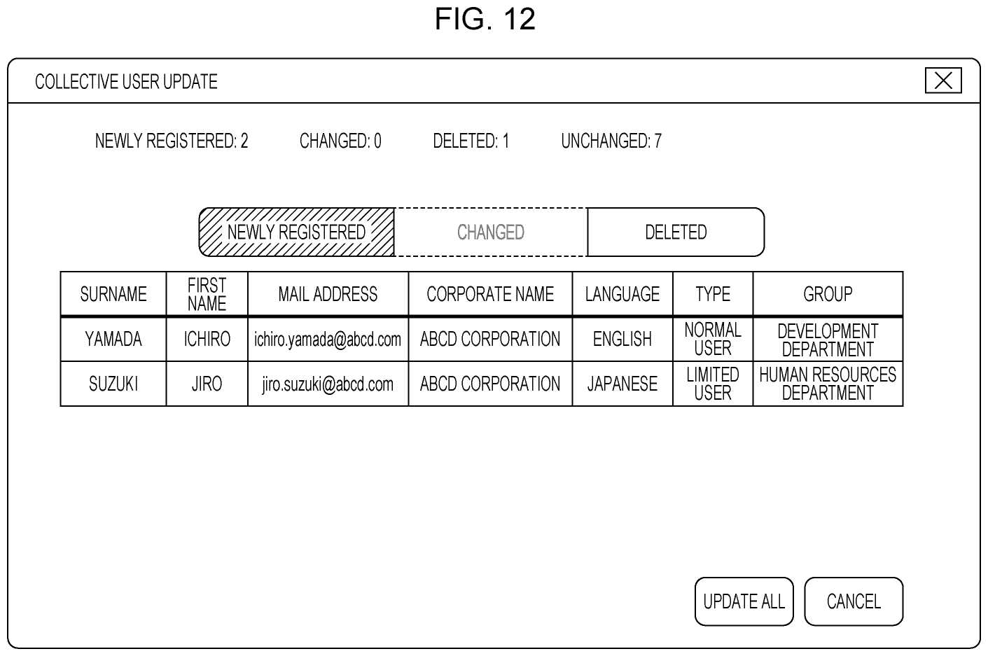

FIGS. 11 and 12 illustrate display examples where there is not a single piece of personal data corresponding to the changed type as the difference type.

Since there is not a single piece of personal data corresponding to the changed type as the difference type in FIG. 11, text information “no user has been changed” is displayed when the user selects the “changed” tab, so that the user may ascertain that there is no personal data corresponding to the changed type as the difference type.

In FIG. 12, the “changed” tab is displayed in a grayed-out fashion in a state where the “newly registered” tab is selected, so that the user may ascertain that there is no personal data corresponding to the changed type as the difference type. In this case, the user is unable to select the “changed” tab even if the user tries to select the “changed” tab, and the number of data pieces corresponding to the changed type displayed above is “0”, so that the user may ascertain that there is no personal data corresponding to the changed type as the difference type.

There are cases where the user desires to further edit each piece of personal data displayed for each difference type as in the above-described manner. An example is a case where there is a mistake in the edited contents and the user desires to correct the mistake. In such a case, based on the contents of an operation received by the operation reception unit 37, the contents of each of the items constituting the displayed personal data are correctable.

However, if an editing authorization is set for each user who desires to further edit user data, the user is not able to edit an item for which the user has no editing authorization. Moreover, with regard to an item that is a standard for managing personal data, such as a mail address, such an item may sometimes be set such that the item is not editable by any user.

Therefore, in this exemplary embodiment, with regard to an unchangeable item, the item is displayed to clearly indicate that it is unchangeable, whereby the user may ascertain an item that is unchangeable due to a lack of an editing authorization.

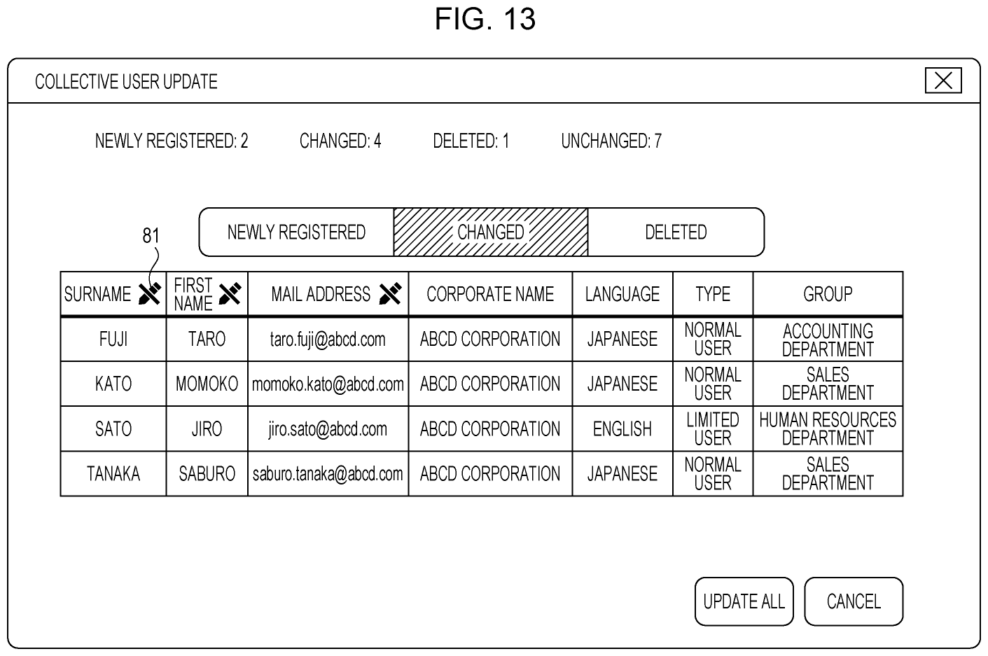

FIGS. 13 to 15 illustrates display examples where unchangeable items are displayed to clearly indicate that they are unchangeable.

FIG. 13 illustrates a case where symbols 81 clearly indicating that items are unchangeable are displayed within name fields of the unchangeable items. In FIG. 13, the symbols 81 are displayed within the name fields of “surname”, “first name”, and “mail address”. It is clear that the user is not able to make changes to the “surname”, “first name”, and “mail address”.

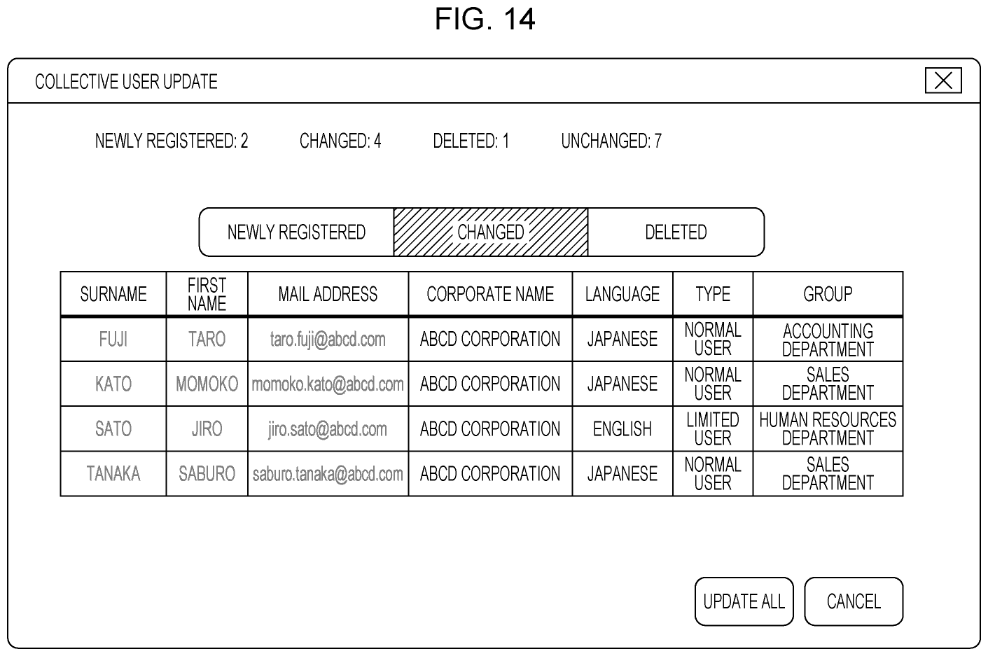

In FIG. 14, the unchangeable items are displayed in a grayed-out fashion, so that it is clear that the user is not able to make changes to the “surname”, “first name”, and “mail address”.

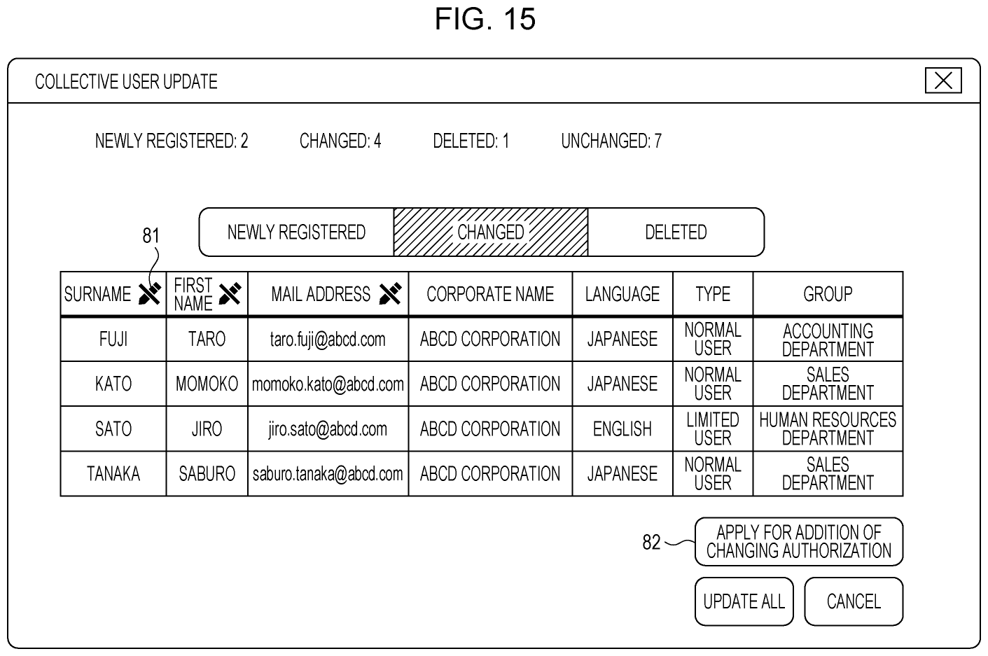

In FIG. 15, an “apply for addition of changing authorization” button 82 is provided in addition to the symbols 81 indicating the non-editable items. A user who is not able to change information about an item, which the user desires to edit, due to a lack of an editing authorization may operate the “apply for addition of changing authorization” button 82, so that a notification indicating a request for an addition of an editing authorization is transmitted to the manager having the editing authorization. If this manager permits the user to edit the items, the non-editable items may be changed.

Alternatively, items that may need approval for change may be set in advance, and when the contents of such items are changed and the “update all” button is operated, the changed contents may be reflected if the manager having the editing authorization permits the change, instead of the changed contents being reflected immediately.

In addition to clearly displaying the unchangeable items, as described above, if multiple items constituting personal data displayed for each difference type include an unchangeable item, the user may be notified that there is an unchangeable item. For example, a text string ““surname”, “first name”, and “mail address” items are not changeable due to lack of editing authorization” may be displayed, so that the user is notified that there are unchangeable items.

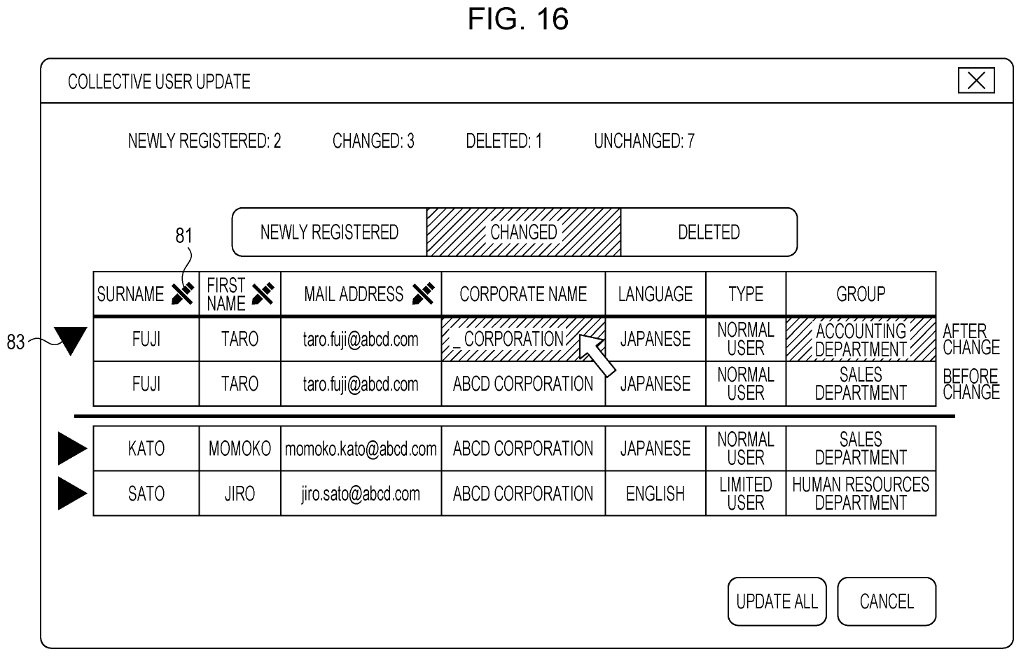

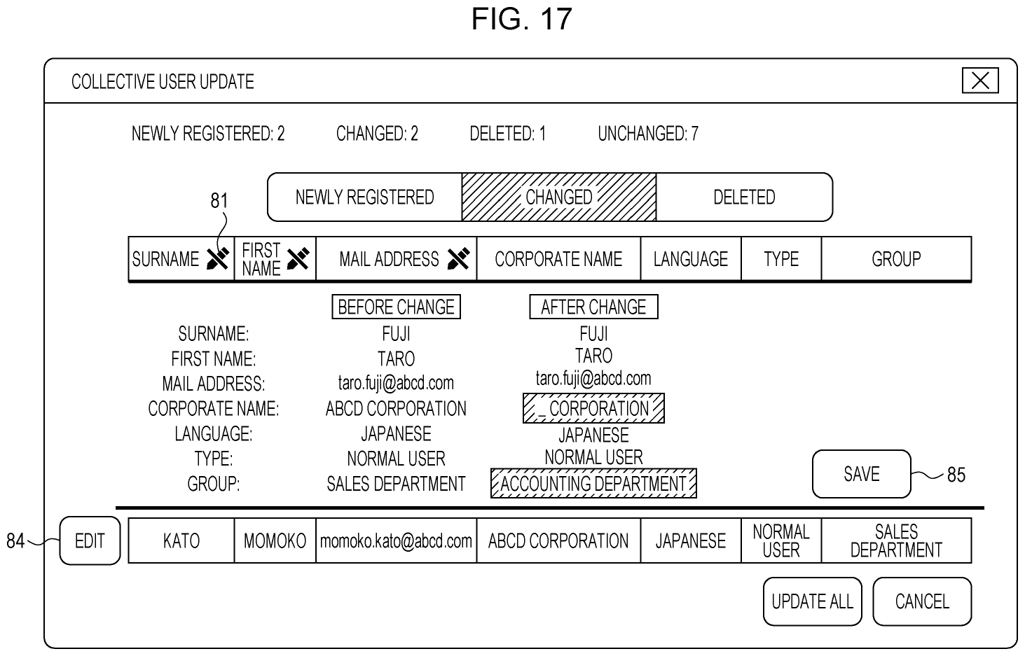

FIGS. 16 and 17 illustrate display examples where personal data displayed for each difference type in this manner is to be edited.

In the display example shown in FIG. 16, an expand button 83 is displayed to the left of each piece of personal data. It is clear that, when the user operates this expand button 83, the user may change the contents of items of the personal data, which is displayed in two rows, namely, upper and lower rows, while viewing unchanged contents.

FIG. 16 illustrates an example where, when the user clicks an editable item, an area indicating the contents of the item switches to a rectangular input area, and information about new contents may be input thereto by operating, for example, the keyboard. When performing such a changing operation, multiple inputtable options may be displayed in advance, and information that the user desires to input may be selected from the multiple displayed options, instead of the user inputting text information using, for example, the keyboard.

In order to change the contents of an item in this manner, the contents different from those prior to the change may be displayed in bold or in a different color, so that it is clear which item has been changed.

Furthermore, FIG. 17 illustrates a display example where unchanged contents and changed contents are displayed side-by-side respectively at left and right sides when personal data displayed for each difference type is to be changed.

In the display example shown in FIG. 17, it is clear that, by operating an edit button 84 displayed to the left of the personal data, unchanged contents and changed contents of the personal data are displayed side-by-side respectively at left and right sides. By displaying the unchanged contents and the changed contents side-by-side respectively at left and right sides in this manner, a large width may be ensured, as compared with when the contents are displayed above and below within a row, so that the user may perform the changing operation more easily.

When the changing operation ends, the user may operate a save button 85, so that the display screen returns to the original display screen.

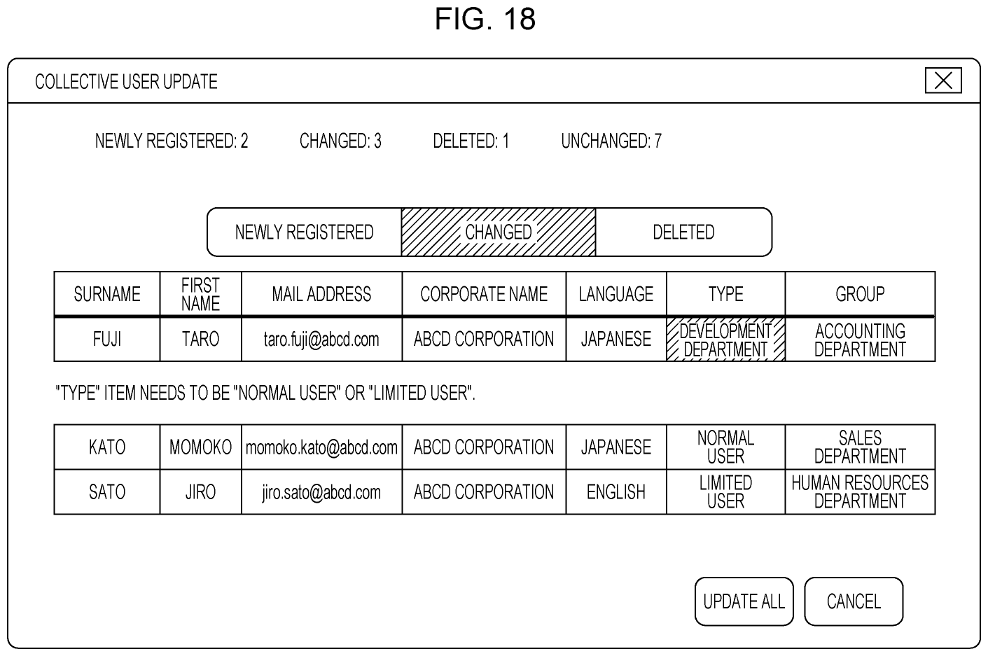

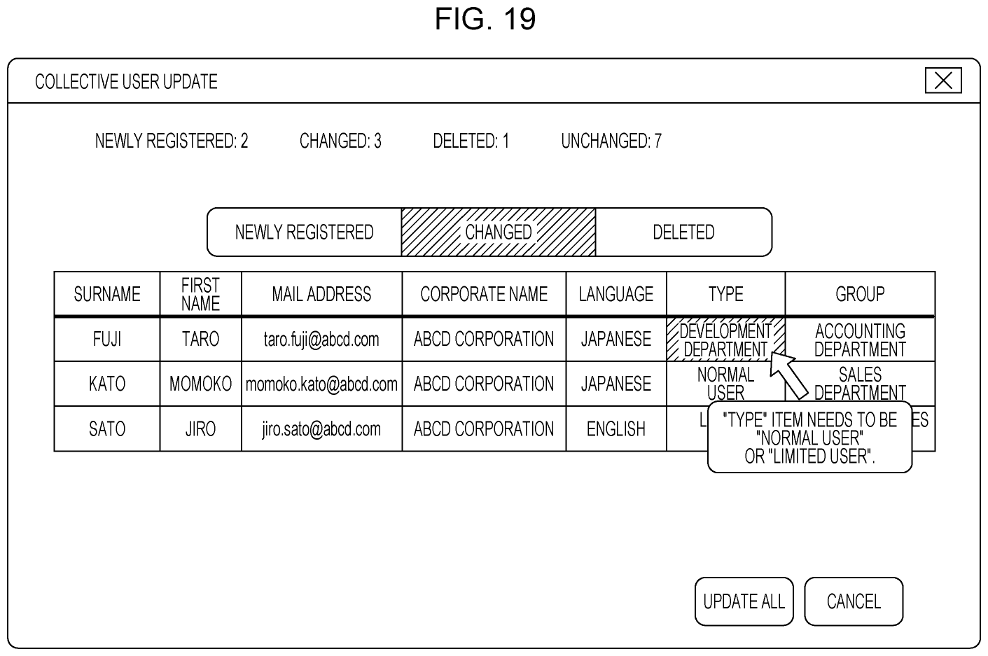

FIGS. 18 and 19 illustrate error display examples where an attribute value of edited user data is abnormal.

In the following description, it is assumed that the “type” item in each piece of personal data needs to be either “normal user” or “limited user”, and other attribute values are not possible.

In the display example in FIG. 18, since the “type” item for “Taro Fuji” is “development department”, a text string ““type” item needs to be “normal user” or “limited user”” is displayed, so that the user is notified of the abnormal attribute value.

In the display example in FIG. 19, the “type” item for “Taro Fuji” is “development department” and is displayed in bold or in a color, such as red, different from that of other text. When the user brings the pointer of the mouse over to “development department”, the text string ““type” item needs to be “normal user” or “limited user”” is displayed, so that the user is notified of the abnormal attribute value.

### Modification

The description of the above exemplary embodiment relates to a case where editing of user data constituted of multiple pieces of personal data is to be managed. Alternatively, the present disclosure is similarly applicable to a case where editing of each type of data constituted of multiple pieces of personal data each including multiple items is to be managed.

The foregoing description of the exemplary embodiment of the present disclosure has been provided for the purposes of illustration and description. It is not intended to be exhaustive or to limit the disclosure to the precise forms disclosed. Obviously, many modifications and variations will be apparent to practitioners skilled in the art. The embodiment was chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

What is claimed is:

1. An information processing apparatus comprising:
a storage unit that stores first data constituted of a plurality of pieces of individual data each including a plurality of items;
an output unit that outputs the first data stored in the storage unit;
an acquiring unit that acquires second data obtained as a result of editing the first data output by the output unit; and
a display controller that performs control to display a list of individual data having a difference between the second data acquired by the acquiring unit and the first data stored in the storage unit, the individual data having the difference being displayed for each of difference types including a newly registered type, a changed type, and a deleted type.

2. The information processing apparatus according to claim 1,
wherein the display controller performs the control to display all pieces of individual data corresponding to the same difference type within a single display region.

3. The information processing apparatus according to claim 2,
wherein the display controller performs the control to display individual data of various difference types in different display regions in accordance with the difference types.

4. The information processing apparatus according to claim 1,
wherein, if individual data corresponding to a certain difference type does not exist, the display controller performs display to clearly indicate that the individual data corresponding to the certain difference type does not exist.

5. The information processing apparatus according to claim 2,
wherein, if individual data corresponding to a certain difference type does not exist, the display controller performs display to clearly indicate that the individual data corresponding to the certain difference type does not exist.

6. The information processing apparatus according to claim 3,
wherein, if individual data corresponding to a certain difference type does not exist, the display controller performs display to clearly indicate that the individual data corresponding to the certain difference type does not exist.

7. The information processing apparatus according to claim 1,
wherein the display controller performs the control to display the number of data pieces of individual data corresponding to each difference type.

8. The information processing apparatus according to claim 2,
wherein the display controller performs the control to display the number of data pieces of individual data corresponding to each difference type.

9. The information processing apparatus according to claim 3,
wherein the display controller performs the control to display the number of data pieces of individual data corresponding to each difference type.

10. The information processing apparatus according to claim 4,
wherein the display controller performs the control to display the number of data pieces of individual data corresponding to each difference type.

11. The information processing apparatus according to claim 5,
wherein the display controller performs the control to display the number of data pieces of individual data corresponding to each difference type.

12. The information processing apparatus according to claim 6,
wherein the display controller performs the control to display the number of data pieces of individual data corresponding to each difference type.

13. The information processing apparatus according to claim 7,
wherein the display controller performs the control such that the number of data pieces is displayed above a center of a display region and a list of individual data corresponding to at least one of the difference types is displayed below a display region for the number of data pieces.

14. The information processing apparatus according to claim 1, further comprising:
a reception unit that receives new editing with respect to the individual data displayed for each difference type by the display controller.

15. The information processing apparatus according to claim 1,
wherein, when the individual data is to be displayed for each difference type, the display controller performs the control to display an item that is unchangeable due to a user not having an editing authorization, such that the item is clearly indicated as being unchangeable.

16. The information processing apparatus according to claim 14, further comprising:
a notification unit that notifies a user that an unchangeable item exists if the plurality of items constituting the individual data displayed for each difference type include an item that is unchangeable due to the user not having an editing authorization.

17. An information processing system comprising:
an information processing apparatus including
a storage unit that stores first data constituted of a plurality of pieces of individual data each including a plurality of items,
an output unit that outputs the first data stored in the storage unit,
an acquiring unit that acquires second data obtained as a result of editing the first data output by the output unit, and
a display controller that performs control to display a list of individual data having a difference between the second data acquired by the acquiring unit and the first data stored in the storage unit, the individual data having the difference being displayed for each of difference types including a newly registered type, a changed type, and a deleted type; and
an editing apparatus that edits the first data output by the output unit and transmits the first data as the second data to the information processing apparatus.

18. A non-transitory computer readable medium storing a program causing a computer to execute a process, the process comprising:
storing first data constituted of a plurality of pieces of individual data each including a plurality of items;
outputting the stored first data;
acquiring second data obtained as a result of editing the output first data; and
performing control to display a list of individual data having a difference between the acquired second data and the stored first data, the individual data having the difference being displayed for each of difference types including a newly registered type, a changed type, and a deleted type.
